(19) United States
(12) Patent Application Publication
(10) Pub. No.: US 2021/0170794 A1
(43) Pub. Date: Jun. 10, 2021

(54) HIGH PERFORMANCE TIRE CORDS

(71) Applicant: KORDSA TEKNIK TEKSTIL A.S., Kocaeli (TR)

(72) Inventor: Sadettin FIDAN, Kocaeli (TR)

(73) Assignee: KORDSA TEKNIK TEKSTIL A.S., Kocaeli (TR)

(21) Appl. No.: 16/770,637

(22) PCT Filed: Nov. 28, 2018
(86) PCT No.: PCT/TR2018/050739

§ 371 Date: Jun. 8, 2020

(30) Foreign Application Priority Data
Dec. 7, 2017 (TR) 2017/19803

(51) Int. Cl. B60C 9/00; D02G 3/48

(52) U.S. Cl. CPC B60C 9/0042; B60C 2009/2257; D02G 3/48

(57) ABSTRACT

High performance textile cords having residual twist in ply-yarns in cord are used as reinforcement in bias and radial pneumatic tires. The high performance textile cords have a residual ply-yarn twist multiplier, wherein the residual ply-yarn twist multiplier is greater than 1,000 and less than 4,000 and a residual twist direction of a plurality of ply-yarns in Z or S direction is in an opposite direction of a cord twist, in S or Z direction.

### CROSS-REFERENCE TO THE RELATED APPLICATIONS

This application is the national phase entry of International Application No. PCT/TR2018/050739, filed on Nov. 28, 2018, which is based upon and claims priority to Turkish Patent Application No. 2017/19803, filed on Dec. 7, 2017, the entire contents of which are incorporated herein by reference.

### TECHNICAL FIELD

The present invention relates to two or three-ply textile (multifil) cords having a residual twist in ply yarns in cord (ply protection twist in opposite direction of the cord twist) which are used as reinforcement in bias and radial pneumatic tires.

### BACKGROUND

The conventional textile tire reinforcement cords are comprised of pre-twisted yarns (plies) in one direction (Z or S) which are all together twisted again in opposite direction(cable or cord twist in S or Z direction). In general, those cords have a balanced twisted structure in which yarn or ply twists are equal to the cable or cord twist. In such cord structures, the residual or resultant yarn twist in cords becomes zero due to untwisting during cord or cable twisting in opposite direction. The zero twisted or untwisted ply yarns in cord have loose parallel filament bundles which have open structure. The main advantage of such a cord structure is its simplicity to produce, and its high breaking strength due to the parallel filaments in cord plies. The breaking strength advantage is valid only for greige or undipped cord. After dipping process, such cords are subjected to a significant reduction in breaking strength due to adhesive dip penetration between the interstices (void channels) of the filament bundles.

According to U.S. Pat. No. 4,877,073, two-ply nylon 6.6 cord in which the first and second plies (yarns) having different twists from each other, has been proposed as low angle overlay (cap ply), which improves uniformity due to is high initial extensibility (low modulus). Such cords enable high process expansion during moulding and curing without excessive tight cord formation, but their effectiveness to prevent tire growth under high speed conditions is poor because of their low modulus. Additionally, such cords have asymmetric structure causing non-uniform stress distribution (load sharing) between the cord plies and also have tendency to buckle under axial compression leading to early cord breaks.

According to U.S. Pat. No. 6,959,534, in order to reduce twisting costs, yarns (plies) are twisted lower levels than cord twist (resulting internal cord torques) and alternating S and Z twisted cords in tire cord fabric has been proposed to solve curling or tip rise problems in calendered fabric. Based on this patent, yarn twist is always less than cord twist and the residual yarn(ply) twist is in the same direction with the cord twist leading to high torsional instabilities. In our invention, yarn twist is always higher than cord twist.

### SUMMARY

The conventional textile cords which are used as tire reinforcement having balanced ply and cord twists with several hundreds of individual parallel filaments have open ply structures in greige form before dipping process.

As explained before, such cords are subjected to the high level of dip (adhesive) penetration into the interstices between the filaments in each ply of the cord even under high cord tensions applied to the cord during dipping in adhesive (RFL or pre-dip) solution.

Two major drawbacks of such highly dip penetrated cords are their high bending stiffness and reduced breaking strength after dipping and hot stretching process. The cords having higher bending stiffness are subjected to the filament damages under cyclic tension and compression which results in reduced retained strength. On the other hand, less initial cord strength requires higher cord density (epdm) or thicker cords in carcass layer in order to provide sufficient burst strength in tire. Higher cord density (epdm) means lower cord-to-cord distance (narrow rivet area) in tire which has high crack initiating potential between the cords due to high shear stresses under dynamic conditions. On the other hand, thicker cords needs higher rubber gauge giving rise to increased rolling resistance in tire.

The high performance (HP) textile cord structures according to invention comprise a sufficient level of residual ply yarn twist in opposite direction of cord twist. In other words, in the preparation step, the ply (yarn) twist is higher than that of cord twist but in opposite direction. The major textile cords in tire reinforcement applications are polyesters (e.g. PET, PEN) and nylons (e.g. nylon 6, nylon 6.6 and nylon 4.6).

According to invention, the filament bundles in such polyester and nylon cord plies are not open (zero twist), but compacted under residual twist and have closed bundle structures.

### BRIEF DESCRIPTION OF THE DRAWINGS

The cord structures and their ply-components according to the invention are illustrated in the accompanying figures, in which:

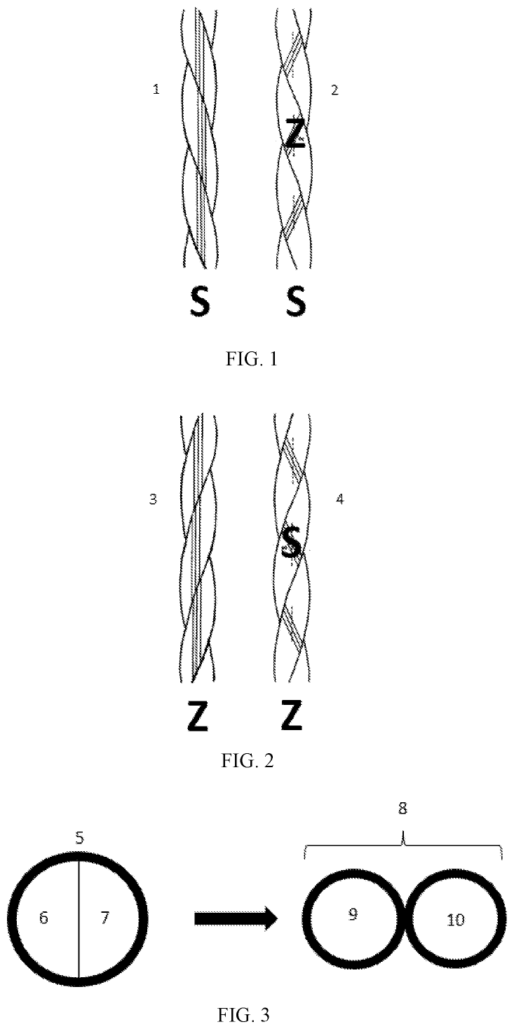

FIG. 1 is the comparison of prior art and according to invention S twisted cords, wherein
1—Prior art S-twisted cord (balanced twisted, Z twist of the ply yarns are equal to the S twist of the cord), and
2—S-twisted cord according to the invention (unbalanced twisted, Z twist of the ply yarns are greater than the S twist of the cord) with residual Z twist.

FIG. 2 is the comparison of prior art and according to invention Z twisted cords, wherein
3—Prior art Z-twisted cord (balanced twisted, S twist of the ply yarns are equal to the Z twist of the cord), and
4—Z-twisted cord according to the invention (unbalanced twisted, S twist of the ply yarns are greater than the Z twist of the cord) with residual S twist.

FIG. 3 shows cross-sectional views of 2-ply cords, wherein
5—2-ply prior art cords with balanced twist having round shape;
6—and 7—are crescent-shaped cord plies;
8—cross-section view of the 2-ply cord according to the invention; and
9—and 10—the plies with residual twist having circular cross-sections in cord according to the invention.

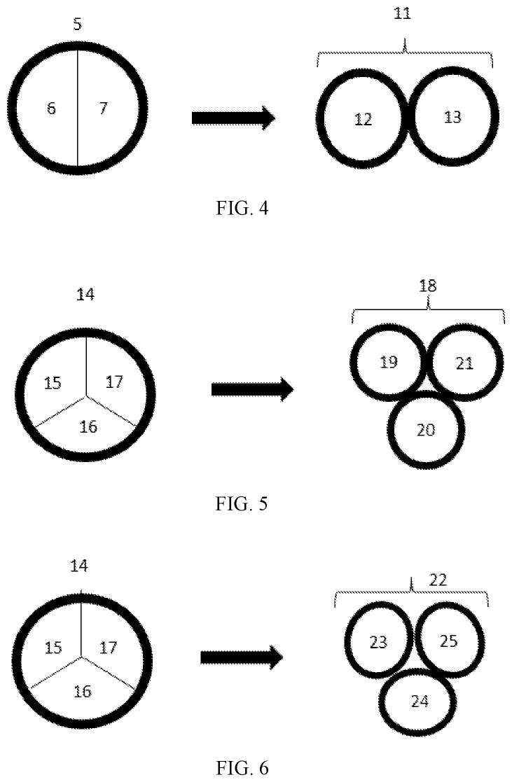

FIG. 4 shows cross-sectional views of 2-ply cords, wherein
11—cross-sectional view of the 2-ply cord according to the invention(treated under high tension), and
12—and 13—the plies with residual twist having oval cross.sections in cord according to the invention.

FIG. 5 shows cross-sectional views of 3-ply cords, wherein
14—3-ply prior art cord with balanced twist with round shape;
15, 16 and 17 triangular shaped plies of prior art cord;
18. cross-sectional view of the 3-ply cord according to the invention; and
19—, 20—, and 21—the plies with residual twist having circular cross-sections in cord according to the invention.

FIG. 6 shows cross-sectional views of 3-ply cords, wherein
22—cross-sectional view of the 3-ply cord according to the invention(treated under high tension), and
23—, 24—and 25—the plies with residual twist having oval cross-sections in cord according to the invention.

### DETAILED DESCRIPTION OF THE EMBODIMENTS

During dipping process of such greige cords having compact and closed filament bundles as plies in cord, adhesive dip solution (RFL) can not penetrate into the depth of cord plies, but be accumulated on the cord surface, which results in low bending stiffness after drying and heat-setting steps, which is important for improved fatigue resistance and breaking strength retention. The residual twist levels in the plies of the textile cords according to the invention are equal to each other but in opposite direction of cord twist (FIG. 1 and FIG. 2).

The maximum residual twist difference between the cord plies is less than 15%. The plies of the high performance textile cords according to the invention have circular (9 and 10 in FIGS. 3, 19, 20 and 21 in FIG. 5) or oval (12 and 13 in FIGS. 4, 23, 24 and 25 in FIG. 6) cross-sections instead of crescent shaped (6 and 7 in FIGS. 3 and 4) or triangular cross-sections of 2 and 3-ply conventional cords. As can be seen from the FIGS. 3, 4, 5 and 6, the circumference of the high performance cords are much higher than that of the conventional cords. In other words, compared to the conventional cords having the same total cord dtex and ply number, the high performance cords have much higher contact surface (adhesive interface) with rubber matrix in tire. Such an increase in contact surface enables more efficient stress transfer between cord plies and rubber matrix under dynamic conditions leading to the enhanced tire durability.

The plies of the high performance cords with residual twist, become more closed and compact during heat-setting process due to their thermal contraction in lateral direction which improves ply stability.

Definitions

Cord: The reinforcement element formed by twisting together two or more plied yarns

Cord ply: Basic yarn components of a cord

Dtex: The gram weight of yarn having 10,000 meter length.

Linear density: Weight per unit length as g/dtex or g/d(denier)

Nylon 6.6: Polyhexamethylene adipamide

Nylon 6: Polycaprolactam

Nylon 4.6: polytetramethylene adipamide

PET: Polyethyleneterephthalate

PEN: polyethylenenaphthalate

POK: Polyolefinketone

Residual twist: Resultant twist of the ply yarns of a cord (ply twist-cord twist)

Total linear density: The sum of the nominal linear densities of 5 the ply yarns of the cord

Two-ply cord: Cord prepared by twisting together two plied yarns

Three-ply cord: Cord prepared by twisting together three plied yarns

Twist: Number of turns per meter (t/m or tpm)

The residual twist and twist multiplier can be calculated according to following formulas:

Residual twist (tpm)=(ply twist-cord twist) (1)

Residual Twist Multiplier(R.T.M.)=residual twist in ply yarn(tpm)x\sqrt{ply yarn dtex} (2)

TABLE 1
Residual Twist Multiplier and The Value of Twist in Ply Yarn
for 1400 dtex Nylon 6.6

| | | Example |
|---|---|---|
| | Residual | (1400 dtex nylon 6.6) |
| PLY YARN | Twist | appr. twists in ply |
| COMPACTNESS | Multiplier | yarn (tpm) |
| OPEN | 0-200 | 0-5.0 |
| OPEN TO LOW | 200-500 | 5.0-13.0 |
| LOW TO SUFFICIENT | 500-1,500 | 13-40 |
| SUFFICIENT TO HIGH | 1,500-4,500 | 40-120 |
| HIGH TO VERY HIGH | 4500-9,000 | 120-240 |
| VERY HIGH | 9,000-15,000 | 240-400 |

The residual twist multiplier of the ply yarns in the high performance cord according to the invention is greater than 1000 and less than 4000 in opposite direction of the cord twist direction.

The preferable residual twist multiplier of the ply yarns in the high performance cord according to the invention is greater than 1500 and less than 2500 in opposite direction of the cord twist direction.

The total linear density of the high performance cord according to the invention is greater than 500 dtex and less than 8000 in opposite direction of the cord twist direction.

The linear densities of the cord plies according to the invention are equal.

The maximum linear density difference between the plies of the cord according to the invention is less than 10%.

The ply yarns in high performance cord according to the invention is comprising nylon 6.6, nylon 6, nylon 4.6, PET, PEN, POK or mixtures thereof.

The high performance cord according to the invention is used as reinforcement in pneumatic radial and bias tires.

What is claimed is:

1. A high performance textile cord, wherein a residual ply-yarn twist multiplier is greater than 1,000 and less than 4,000 and a residual twist direction of a plurality of ply-yarns in Z or S direction is in an opposite direction of a cord twist, in S or Z direction.

2. The high performance textile cord according to claim 1, wherein the residual ply-yarn twist multiplier of the high performance textile cord is greater than 1,500 and less than 2,500.

3. The high performance textile cord according to claim 1, wherein a total nominal linear density of the high performance textile cord is higher than 500 dtex and less than 8000 dtex.

4. The high performance textile cord according to claim 1, wherein a plurality of cord plies have equal linear density values.

5. The high performance textile cord according to claim 1, wherein a maximum linear density difference between a plurality of plies of the high performance textile cord is less than 10%.

6. The high performance textile cord according to claim 1, wherein a residual twist difference between a plurality of plies of the high performance textile cord is less than 15%.

7. The high performance textile cord according to claim 1, wherein the plurality of ply-yarns in the high performance textile cord is nylon 6.6.

8. The high performance textile cord according to claim 1, wherein the plurality of ply-yarns in the high performance textile cord is nylon 6.

9. The high performance textile cord according to claim 1, wherein the plurality of ply-yarns in the high performance textile cord is nylon 4.6.

10. The high performance textile cord according to claim 1, wherein the plurality of ply-yarns in the high performance textile cord is polyethylene terephthalate (PET).

11. The high performance textile cord according to claim 1, wherein the plurality of ply-yarns in the high performance textile cord is polyethylene naphthalate (PEN).

12. The high performance textile cord according to claim 1, wherein the plurality of ply-yarns in the high performance textile cord is polyolefin ketone (POK).

13. The high performance textile cord according to claim 1, wherein the high performance textile cord is used as a reinforcement in pneumatic radial and bias tires.
